(19) United States
(12) Patent Application Publication
(10) Pub. No.: US 2005/0015294 A1
(43) Pub. Date: Jan. 20, 2005

(54) Method and system for modeling and simulating an automobile service facility

(75) Inventors: Edward Williams, Northville, MI (US); John Garfield Graham, Plymouth, MI (US); William Howard Burnett, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/619,664

(22) Filed: Jul. 15, 2003

(51) Int. Cl. G06F 17/60

(52) U.S. Cl. 705/10

(57) ABSTRACT

Embodiments include receiving data defining customer characteristics, facility capabilities and financial data for an automobile service facility, generating a computer model of the service facility based on the customer characteristics, facility capabilities, and financial data, and calculating one or more quantitative indications of expected facility performance based on the model. Computer experiments may be conducted to identify one or more service facility characteristics that have an impact on service facility efficiency or revenue. Computer experiments may result in the derivation of one or more quantitative expressions interrelating one or more of the service facility characteristics that have an impact on service facility efficiency or revenue. Based on one or more aspects of the foregoing, aspects of the service facility may be changed in an attempt to improve efficiency or revenue.

### BACKGROUND OF THE INVENTION

1. Field of the Invention

The present invention relates generally to data processing methods and systems and, more particularly, to a computer-implemented method and system for modeling and simulating an automotive service facility.

2. Background of the Invention

Modeling of automotive facilities enables management to make decisions based on quantitative data. The decisions of importance include staffing levels, working hours, pricing, training, workflow, and facility sizing. Simulation modeling includes the effects of randomness and uncertainty and consequently provide more realistic output to decision makers. Armed with more realistic data, management can make decisions that are more robust and better able to meet all of the business conditions likely to face the service shop. Because of more realistic analysis, the shop is more likely to be sized, staffed, and operated in a more profitable and efficient manner.

Prior art methods typically include hand and simple spreadsheet calculations based on average values for the variables under study. Extensive use of thumb rules (big picture approximations of complex relationships) is also common in the prior art. Prior art methodologies do not include the randomness and uncertainty present in the real service shop. Consequently the robustness of the analysis is severely compromised.

Prior art methods typically assume that all variables are deterministic (known, not subject to uncertainty or randomness) and can be characterized by their mean values. Consequently, all calculations are based on these mean values and may be subject to large errors because of the true stochastic (random, uncertain) nature of the real word. For example, 60 customers may arrive at the service shop on average and 20 technicians may work at the shop on average. On average, the technician work force can handle the customer traffic. However, on any given day, 70 customers may arrive and be serviced by only 15 technicians due to illness, training, or vacation. The customer waiting times in the 70/15 case are significantly more than in the 60/20 case. Consequently, the prior art methods only provide average answers that may hide very different real world results.

Software applications currently exist for constructing generic models of dynamic systems and processes, and performing integrated simulations. One such application is SIMUL8 and is available from SIMUL8 Corporation, 2214 Rock Hill Road, Suite 501, Herndon, Va. 20170. One disadvantage of such applications is their inability to effectively or efficiently identify which input factors (typically among hundreds of input factors) have the most significant impact on efficiency and revenue in a business simulation.

### SUMMARY OF THE INVENTION

Embodiments of the present invention facilitate true-to-life computer modeling and simulation of automobile service facilities based on historical and/or user-defined data. As such, a model generated in accordance with the present invention can quickly and efficiently quantify important factors such as service facility efficiency, profitability, performance, etc. “What-if” analyses may be conducted in which the model simulates modifications to the operation or configuration of the service facility, equipment changes, staffing changes, policy changes, etc.

In addition to the modeling and simulation aspects of the present invention, computer experiments may be conducted to derive a mathematical expression quantifying the relative significance of service facility metrics that significantly impact service facility performance, profitability, efficiency, etc. This feature of the present invention helps an analyst or service facility manager to more effectively focus on those aspects of service facility that will have the greatest return.

Embodiments of the present invention include a method and system for modeling an automobile service facility. These embodiments include receiving data defining customer characteristics, facility capabilities and financial data for an automobile service facility, generating a computer model of the service facility based on the customer characteristics, facility capabilities, and financial data, and calculating one or more quantitative indications of expected facility performance based on the model.

Additionally, computer experiments may be conducted to identify one or more service facility characteristics that have an impact on service facility efficiency or revenue. The computer experiments may result in the derivation of one or more quantitative expressions interrelating one or more of the service facility characteristics that have an impact on service facility efficiency or revenue.

Based on one or more aspects of the foregoing, aspects of the service facility may be changed in an attempt to improve efficiency or revenue.

Statistical probability concepts may be implemented to account for uncertainty in at least a portion of the input/received data.

Customer characteristics may include customer arrival rates, desired services, or the number of desired services per customer.

Facility capabilities may include personnel quantities, technician skills, technician efficiency, work hours, or personnel absences. The facility capabilities may include one or more statistical indicia of one or more service times associated with customer experiences at the service facility.

The financial data may include one or more statistical indicia of part and labor revenue associated with one or more service types.

The quantitative indication(s) of expected facility performance may include expected financial performance, technician utilization, or time to process customers. The time to process customers may include the time to process discrete customer services or the time of overall customer experience at the service facility.

### BRIEF DESCRIPTION OF THE DRAWINGS

FIG. 1 is a block flow diagram by service department location illustrating a preferred simulation model workflow in accordance with the present invention;

FIG. 2 is a schematic illustrating a preferred model simulating a vehicle service/repair facility in accordance with the present invention; and

FIG. 3 is a chart illustrating an example cumulative distribution function (log-normal) for an example input parameter (“As-10 Service Time”) in accordance with the present invention.

### DETAILED DESCRIPTION OF THE PREFERRED EMBODIMENT(S)

One embodiment of the present invention is a computer application for modeling workflow at an automobile service facility. A preferred computing system for hosting the application is a Dell Precision Workstation 340 having a 2.53 GHz Intel Pentium 4 processor, a 533 MHz bus frequency, 1 GB dual-channel RDRAM memory, and 100 GB internal storage capacity. This computing system is available from Dell Computer Corporation, One Dell Way, Round Rock, Tex. 78682. Notably, however, a wide variety of computing systems and arrangements may be implemented. Embodiments of the present invention may be implemented in a stand-alone fashion on a single computer such as the Dell Precision Workstation 340, or be executed at a server or mainframe in a networked computing environment.

In accordance with a preferred embodiment of the present invention, the computer system is operably configured to execute a software application for performing integrated simulations. One such application is SIMUL8 and is available from SIMUL8 Corporation, 2214 Rock Hill Road, Suite 501, Herndon, Va. 20170.

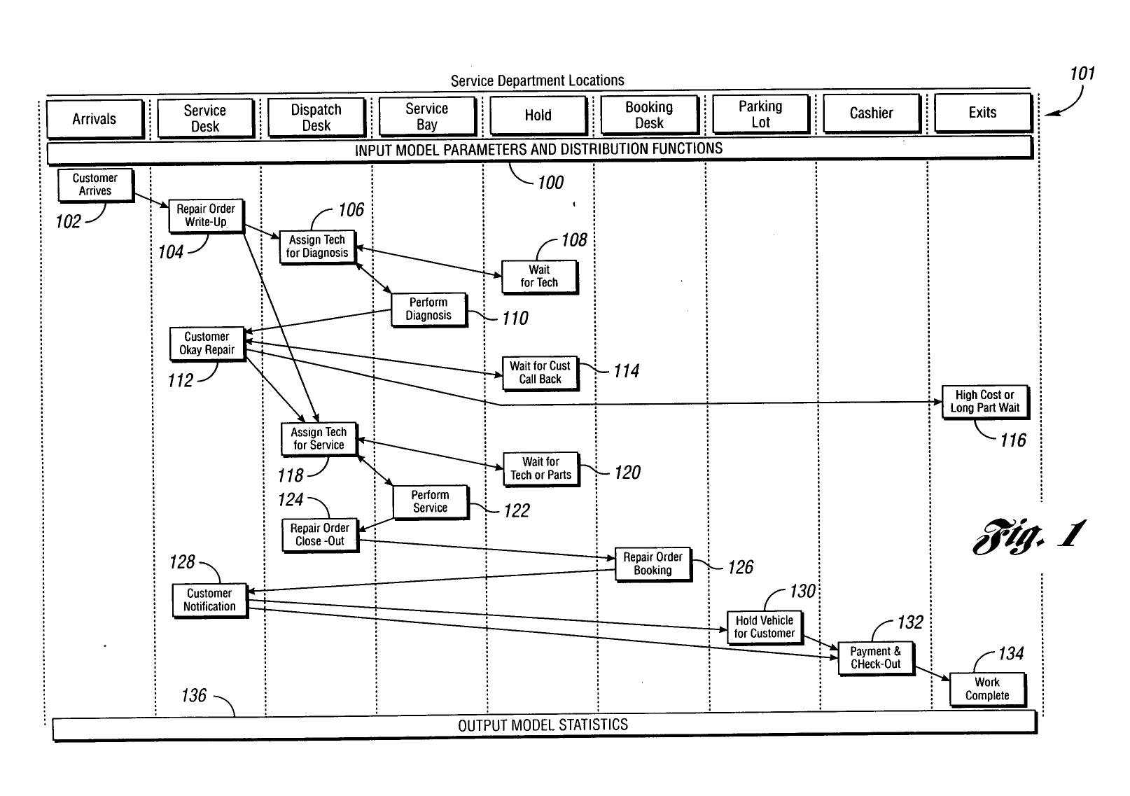

FIG. 1 is a block flow diagram illustrating a preferred logic for implementing the present invention. Notably, the content or arrangement of items illustrated and described with respect to FIG. 1 may be modified or rearranged to best fit a particular implementation of the present invention.

In row 101, column headings for the flow diagram pertaining to locations in a service shop are provided. Vertical dashed lines shown on FIG. 1 separate activity according to service department location.

At step 101, model and distribution function parameters are input into the model. Table 1 contains example input parameters. Notably, these parameters may be modified, limited or expanded to best fit a particular implementation of the model.

TABLE 1
EXAMPLE PARAMETER DESCRIPTIONS

Customer arrival rate count - average week
Customer arrival rate parameters for three
unique, time of day based, customer arrival
processes
Fraction of technicians working Saturday
Fraction of total service time devoted to
diagnosis for each service type
Hold time for repair order when technician not
available
Non-technician personnel quantities
Parking window determination - used to specify
minimum time vehicle held in parking lot
Part time cashier work schedule
Part waiting time threshold value - used to
determine if customer cancels a repair order item
due to a long wait for parts
Probability customer answers phone call
requesting service authorization
Probability customer authorizes service
Probability customer cancels service due to lack
of parts
Probability customer waits in lounge for service
Probability of occurrence for each of eighteen
unique service types (cumulative)
Probability of occurrence for one to seven
service items on a repair order (cumulative)
Probability parts available for each service type
Probability technician absent due to illness,
vacation, or training for one day
Regression function parameters - part and labor
revenue slope and intercept
Technician break durations and start times
Technician efficiency ratings
Technician quantities
Technician skill matrix - nineteen technicians
mapped against eighteen service types
Technician weekly hour count

In one embodiment, distribution functions may be log-normal, normal or triangular. Table 2 contains example distribution functions and the corresponding distribution type.

TABLE 2

| DISTRIBUTIONS | TYPE |
|---|---|
| Labor Revenue Residual | Normal |
| Part Revenue Residual | Normal |
| Part Wait Time | Triangular |
| Service Time | Log Normal |
| Customer Callback Time | Triangular |
| Customer Notify Time | Triangular |
| Customer OK Time | Triangular |
| Write-up Time | Triangular |
| Closeout Time | Triangular |
| Dispatch Time | Triangular |
| Booking Time | Triangular |
| Cashier Time | Triangular |
| Arrivals - Early Morning | Exponential |
| Arrivals - Late Morning | Exponential |
| Arrivals - Afternoon | Exponential |
| Arrivals - All Day | Exponential |

At step 102, the model generates new customers. In one embodiment of the present invention, new customers are represented by a repair order. In accordance with this embodiment, repair orders may be generated according to a five-step process. The first step involves selecting an appropriate inter-arrival time distribution function (e.g., arrivals—early morning; arrivals—late morning; arrivals—afternoon, etc.) based upon a time of day. The second step may involve generating a random number between 0 and 1 (e.g., 0.6457). The third step may involve obtaining an inter-arrival time associated with a cumulative probability equal to the random number generated in step 2 from the inter-arrival time distribution selected in step 1. The fourth step may involve generating a new customer at the current model time of day plus the inter-arrival time obtained in step 3. The fifth step may involve repeating steps 1 through 4 when the model time of day advances to the value calculated in step 4.

Additionally, the model may determine the number of service items per repair order. In one embodiment of the present invention, the number of service items per repair order is determined with a process including three steps. The first step may include generating a random number between 0 and 1 (e.g., 0.7592). The second step may include comparing the random number generated in the first step with the cumulative probability of having between 1 and 7 items on a repair order. Table 3 below contains example probabilities corresponding to the number of items on a repair order.

TABLE 3

| NUMBER OF ITEMS | |
|---|---|
| ON REPAIR ORDER | CUMULATIVE PROBABILITY |
| 1 | 0.5557 |
| 2 | 0.7794 |
| 3 | 0.8793 |
| 4 | 0.9322 |
| 5 | 0.9600 |
| 6 | 0.9806 |
| 7 | 1.0000 |

The third step may include selecting the appropriate number of service items for the repair order. For example, if the random number generated is 0.7592, two items would be assigned to the repair order because the random number 0.7592 is greater than or equal to 0.5557, but less than 0.7794. The model may also assign service types to the repair order utilizing a random number algorithm similar to that illustrated and described above with respect to service times per repair order. Table 4 corresponds example service types to various cumulative probabilities.

TABLE 4

| Service Type | Cumulative Probability |
|---|---|
| AS-10 | 0.3493 |
| AS-11 | 0.4009 |
| AS-12 | 0.4481 |
| AS-13 | 0.5358 |
| AS-14 | 0.5922 |
| AS-16 | 0.6251 |
| AS-17 | 0.6315 |
| AS-18 | 0.6831 |
| AS-120 | 0.6892 |
| AS-131 | 0.7490 |
| W-01 | 0.7756 |
| W-02 | 0.7919 |
| W-03 | 0.7988 |
| W-04 | 0.8023 |
| W-05 | 0.8504 |
| W-06 | 0.9017 |
| W-07 | 0.9398 |
| W-08 | 1.0000 |

The model may then calculate statistics including cumulative repair order arrival count and cumulative service items arrival count. The model may assign values to various service item characteristics based upon input data, distribution functions, and random numbers. Table 5 includes example service item parameters and corresponding calculations.

TABLE 5

| SERVICE ITEM | |
|---|---|
| PARAMETERS | DESCRIPTION/CALCULATION |
| Service Bay | Obtained from service time distribution |
| Total Time (flat | function. |
| rate) | |
| Service Bay | Total Service Time (flat rate) * Diagnosis |
| Diagnosis Time | Fraction * Random Number |
| (flat rate) | |
| Service Bay | Total Service Time (flat rate) − Service |
| Service Time | Bay Diagnosis Time (flat rate) |
| (flat rate) | |
| Part Revenue | Obtained from a part revenue |
| Residual | distribution function. |
| Part Revenue | Part Revenue Intercept + [Total Service |
| | Time (flat rate) * Part Revenue Slope] + Part |
| | Revenue Residual |
| Labor Revenue | Obtained from a labor revenue |
| Residual | distribution function. |
| Labor Revenue | Labor Revenue Intercept + [Total |
| | Service Time (flat rate) * Labor |
| | Revenue Slope] + Labor Revenue |
| | Residual. |
| Customer will | Obtained by comparing a random number |
| authorize | to an input threshold value. |
| service? (yes or | |
| no) Customer | |
| will wait for | |
| parts? (yes or | |
| no). Customer | |
| will wait in | |
| lounge? (yes or | |
| no) | |

At the end of step 102, the customer (repair order) is routed to the service desk.

At step 104, a service advisor documents the requested services on the repair order. The model determines the time at the service desk from a unique “write-up” distribution function. For warranty, general maintenance and tire-related items, the repair order is routed to the dispatch desk for assignment of a service technician. For all other work, the repair order is routed to the dispatch desk for assignment of a diagnosis technician.

At step 106, a dispatcher attempts to assign a technician for diagnosis based upon the requested services. If a technician is unavailable, the repair order is routed to a holding area. If a technician is available, the repair order is routed to a service bay. The model determines a time at the dispatch desk from a unique dispatch desk “diagnose dispatch” distribution function.

At step 108, the repair order is held until a new technician availability check is required. Preferably, the repair order is held for a predetermined amount of time and then routed to the dispatch desk.

At step 110, a technician performs a diagnosis. The model determines a time-in-service bay value from the previously determined diagnosis time and the efficiency of the assigned technician (Time-in-Service Bay=Service Bay Diagnosis Time (Flat Rate)/Technician Efficiency). The model additionally calculates statistics, including cumulative technician work time for each service type. If a repair order contains multiple service items requiring diagnosis, the repair order is routed to the dispatch desk for additional technician dispatching. If all service items are diagnosed, the repair order is routed to the service desk.

At step 112, the service advisor contacts the customer to obtain authorization to perform necessary repairs. The model determines a time-at-service desk value from a unique service desk “customer authorization” distribution function. For all services that have been authorized, the repair order is routed to the dispatch desk for assignment of a service technician. If all repair items are disapproved and/or the customer refuses to wait for parts, the repair order is routed to the exit location. If a customer is not reached, the repair order is routed to the holding area.

At step 114, the repair order is held until a customer calls the service advisor back or vise versa. The model determines a holding time from a unique “awaiting customer callback” distribution function. The repair order is then routed to the service desk for customer authorization.

If all items are disapproved and/or the customer refuses to wait for all parts, the customer exits the dealership as represented in step 116. The model calculates statistics, including repair order exit count (high cost), repair order exit count (long part way), service item exit count (high cost), and service item exit count (long part way).

At step 118, the dispatcher attempts to assign a technician for service based upon the requested services. If the technician or parts are unavailable, the repair order is routed to a holding area. If a technician is available, the repair order is routed to a service bay. The model determines a time at dispatch desk value from a unique dispatch desk “service dispatch” distribution function.

At step 120, the repair order is held until parts are available or a new technician availability check is required. The model determines a holding time from a predetermined time or a “parts wait” distribution function. The repair order is then routed to the dispatch desk.

At step 122, a technician performs the requested service. The model determines a time-in-service bay value from the previously determined service time and the efficiency of the assigned technician (Time-in-Service Bay=Service Bay Service Time (Flat Rate)/Technician Efficiency). The model calculates statistics, including cumulative technician work time for each service type. If a repair order contains multiple service items requiring service, the repair order is routed to the dispatch desk for additional technician dispatching. If all service items are complete, the repair order is routed to the dispatch desk for closeout.

At step 124, the dispatcher closes out the repair order and credits the technicians with hours worked. The model determines a time at dispatch desk value from a unique dispatch desk “closeout” distribution function. The repair order is then routed to the booking desk.

At step 126, a booker calculates revenue from technician hours worked and parts installed. The model determines a time at booking desk value from a unique booking desk distribution function. The model then calculates statistics, including, but not limited to, those contained in Table 6.

TABLE 6
EXAMPLE STATISTICS CALCULATED

Cumulative part revenue for 1^{st}, 2^{nd}, . . . ,
7^{th} item on repair order
Cumulative labor revenue for 1^{st}, 2^{nd}, . . . ,
7^{th} item on repair order
Cumulative part revenue for each service
type
Cumulative labor revenue for each service
type

Finally, the repair order is routed to the service desk.

At step 128, the service advisor notifies the customer that the repair order is complete. The model determines a time at service desk value from a unique service desk “customer notification” distribution function. If the customer is waiting in the lounge, the repair order is routed to the cashier. If the customer is not waiting in the lounge, the repair order is routed to the parking lot.

At step 130, the vehicle is held in the parking lot until the customer arrives for pickup. The model assigns a parking lot time so that most vehicles will exit during the last several hours of the day. For example: Parking time=(Day End Time−Parking Window Time−Time Enter Parking)+((Random number*Parking Window Time)−5). The repair order is then routed to the cashier.

At step 132, the customer pays for service and retrieves his/her keys. The model determines a time at cashier value from a unique cashier distribution function. The model also calculates statistics, including, but not limited to, repair order service complete count, service items service complete count, and cumulative time at each service shop location. The repair order is then routed to the dealership exit. As represented by step 134, the customer then exits the dealership.

At step 136, the model outputs statistics of interest. In one embodiment, the statistics are output in a spreadsheet format. The spreadsheet may be configured to calculate statistics including, but not limited to, technician utilization, service desk utilization, dispatch desk utilization, booking desk utilization, cashier utilization, average part revenue per repair order, average labor revenue per repair order, average total revenue per repair order, and average time in dealer per repair order. Other outputs include total repair orders, total services performed, customer departures, flat rate and actual technician hours, total dealership hours, flat rate versus actual technician hours, and actual technician versus total dealership hours.

Table 7 contains a plurality of example simulation model factor inputs. Notably, these factors may be supplemented, modified or otherwise tailored to best fit a particular implementation of the present invention. Some of the factors contained in Table 7 have multiple input values. For example, factor #8 “probabilities-service type” has a total of 18 input values. In this example, each of these values represent a probability for each of 18 different service types. Preferably, the total probability sums to 100%.

The control class factors represent factors that a service facility manager has some control over and can readily modify to optimize the model simulation. The fixed factors represent factors that a service facility manager typically does not have control over. In some instances, however, certain fixed values may be readily adjusted.

TABLE 7
# Class

| | | | | |
|---|---|---|---|---|
| Factor No. | Description | Factors | Control | Fixed |

ARRIVALS

| | | | |
|---|---|---|---|
| 1 | Arrival fraction-early | 1 | X |
| | bird | | |
| 2 | Arrival fraction- | 1 | X |
| | scheduled | | |
| 3 | Arrival fraction- | 1 | X |
| | unscheduled | | |
| 4 | Arrival window-afternoon | 6 | X |
| 5 | Arrival window-early | 1 | X |
| | morning | | |
| 6 | Arrival window-late | 1 | X |
| | morning | | |
| 7 | Probabilities-lines per | 7 | X |
| | repair order | | |
| 8 | Probabilities-service | 18 | X |
| | type | | |
| 9 | Total weekly arrivals | 1 | X |

PERSONNEL

| | | | | |
|---|---|---|---|---|
| 10 | Booker quantity | 1 | X | |
| 11 | Cashier-part time, | 1 | X | |
| | fraction of day worked | | | |
| 12 | Cashier quantity-full time | 1 | X | |
| 13 | Cashier quantity-part time | 1 | X | |
| 14 | Dispatcher quantity | 1 | X | |
| 15 | Service advisor quantity | 1 | X | |
| 16 | Technician (existing) | 19 | X | |
| | efficiency | | | |
| 17 | Technician (existing) | 19 | X | |
| | quantity | | | |
| 18 | Technician (existing) | 79 | | X |
| | skill matrix (existing | | | |
| | skills) | | | |
| 19 | Technician (existing) | 111 | X | |
| | skill matrix (new skills) | | | |
| 20 | Technician (existing) | 19 | X | |
| | weekly work hours | | | |
| 21 | Technician (new) skill | 9 | X | |
| | matrix | | | |
| 22 | Technician (new) weekly | 1 | X | |
| | work performed | | | |
| 23 | Technician Saturday work | 1 | X | |
| | fraction | | | |
| 24 | Technician vacation & | 1 | X | |
| | illness probability | | | |

LOCATIONS

| | | | |
|---|---|---|---|
| 25 | Booking desk time dist | 3 | X |
| | (min, mode, max) | | |
| 26 | Cashier time dist (min, | 3 | X |
| | mode, max) | | |
| 27 | Customer callback time | 3 | X |
| | dist (min, mode, max) | | |
| 28 | Dispatch desk (closeout) | 3 | X |
| | time dist (min, mode, max) | | |
| 29 | Dispatch desk (dispatch) | 3 | X |
| | time dist (min, mode, max) | | |
| 30 | Service bay time dist | 36 | X |
| | ([mean, std dev] 18 | | |
| | services) | | |
| 31 | Service desk (customer | 3 | X |
| | notify) time dist (min, | | |
| | mode, max) | | |
| 32 | Service desk (customer ok) | 3 | X |
| | time dist (min, mode, max) | | |
| 33 | Service desk (write-up) | 3 | X |
| | time dist (min, mode, max) | | |

REVENUE

| | | | | |
|---|---|---|---|---|
| 34 | Labor $ slope | 18 | X | |
| 35 | Labor $ residual dist | 36 | | X |
| | ([mean, std dev] 18 | | | |
| | services) | | | |
| 36 | Part $ slope | 18 | X | |
| 37 | Part $ residual dist | 36 | | X |
| | ([mean, std dev] 18 | | | |
| | services) | | | |

OTHER

| | | | |
|---|---|---|---|
| 38 | Daily parking window | 1 | X |
| 39 | Daily service department | 6 | X |
| | hours | | |
| 40 | Diagnosis fraction of | 1 | X |
| | total service time | | |
| 41 | Dispatch hold time (wait | 1 | X |
| | time for technician) | | |
| 42 | Part wait time dist (min, | 54 | X |
| | mode, max) 18 | | |
| 43 | Probability customer | 1 | X |
| | answer phone | | |
| 44 | Probability customer | 18 | X |
| | authorize service | | |
| 45 | Probability customer | 1 | X |
| | cancel service-long part | | |
| | wait | | |
| 46 | Probability customer wait | 1 | X |
| | in lounge | | |
| 47 | Probability parts | 18 | X |
| | available | | |
| 48 | Threshold for long part | 1 | X |
| | wait | | |

Factor numbers 1-9 are related to customer arrivals. Factor #1 corresponds to the daily fraction of costumers that arrive before the dealership opens. Factor #2 corresponds to the daily fraction of arriving customers that have scheduled appointments. Factor #3 corresponds to the daily fraction of arriving customers that do not have scheduled appointments. Factor #4 corresponds to the balance of a day not allocated to early and late morning windows. Factor #5 corresponds to the daily time window allocated for early bird arrivals. Factor #6 corresponds to the daily time window allocated for scheduled arrivals. Factor #7 corresponds to the probability of a repair order having one, two, . . . or seven repair items. This factor preferably sums to 100%. Factor #8 corresponds to the probability of an occurrence for each of the 18 service types. Preferably, these probabilities sum to 100%. Factor #9 corresponds to the expected number of customers arriving during a six-day work week.

Factor numbers 10-24 relate to service facility personnel. Factor #10 corresponds to the number of people working at the booking desk. Factor #11 corresponds to the fraction applied to daily dealership hours to determine part-time cashier hours. Factor #12 corresponds to the number of full-time cashiers. Factor #13 corresponds to the number of part-time cashiers. Factor #14 corresponds to the number of people working the dispatch desk. Factor #15 corresponds to the number of people working at the service desks. Factor #16 corresponds to the ratio of flat hours billed to clock hours worked. This value may be determined from historical data. Factor #17 corresponds to the number of existing technicians. Factor #18 corresponds to a list of existing skills for each technician. Factor #19 corresponds to a list of potential new skills for each technician. Factor #20 corresponds to a total number of hours worked during a six-day work week. Factor #21 corresponds to a list of skills for a new technician. Factor #22 corresponds to a total number of hours worked during a six-day work week. Factor #23 corresponds to the fraction of technician work force working on any given Saturday. Factor #24 corresponds to the probability that a technician will be absent on a given day due to illness or vacation.

Factor numbers 25-33 relate to locations within the service facility being modeled. Factor #25 corresponds to the minimum, mode and maximum times expected at the booking desk. These values are used to generate a triangular distribution function. Factor #26 corresponds to the minimum, mode and maximum times expected at the cashier. These values are used to generate a triangular distribution function. Factor #27 corresponds to a minimum, mode and maximum expected callback times. These values are used to generate a triangular distribution function. Factor #28 corresponds to a minimum, mode and maximum time expected for closeout. These values are used to generate a triangular distribution function. Factor #29 corresponds to a minimum, mode and maximum time expected for dispatch. These values are used to generate a triangular distribution function. Factor #30 corresponds to a mean and standard deviation of times expected in the service bay for each service type. These values are used to generate a log normal distribution. Factor #31 corresponds to a minimum, mode and maximum time expected for customer notification. These values are used to generate a triangular distribution. Factor #32 corresponds to a minimum, mode and maximum time expected for customer ok. These values are used to generate a triangular distribution. Factor #33 corresponds to a minimum, mode and maximum time expected for write-up. These values are used to generate a triangular distribution function.

Factor numbers 34-37 relate to service facility revenue. Factor #34 corresponds to a slope of a line describing the relationship between labor revenue and labor hours. Factor #35 corresponds to a mean and standard deviation of residuals associated with a regression equation using “labor $ slope”. This value is used to generate a normal distribution. Factor #36 corresponds to the slope of a line describing the relationship between part revenue and labor hours. Factor #37 corresponds to a mean and standard deviation of residuals associated with a regression equation using “part $ slope”. This value is used to generate a normal distribution.

Factor numbers 38-48 correspond to other miscellaneous simulation model input factors. Factor #38 is used to calculate parking time. Factor #39 corresponds to the number of business hours for each work day. Factor #40 is a fraction of total service time devoted to diagnosis. Factor #41 is the time a repair order holds before returning to a dispatch desk for another technician assignment try. Factor #42 includes a minimum, mode and maximum time expected for part delivery. These values are used to generate a triangular distribution function. Factor #43 corresponds to a probability that a customer answers a phone call requesting authorization to perform service. Factor #44 corresponds to the probability that a customer authorizes service. This factor may be cost related. Factor #45 corresponds to the probability that a customer refuses service due to long part wait. Factor #46 corresponds to a probability that a customer waits in a lounge during a service visit. Factor #47 corresponds to the probability that parts are located at the dealership. Factor #48 corresponds to a threshold value for long part wait such that if a part wait time is less than the threshold, the customer will not cancel the service.

In accordance with a preferred embodiment of the present invention, specific values for variables of interest (e.g., service time, repair time, repair type, etc.) may be generated with the following methodology or a variation thereof. First, a cumulative distribution function is created for the variable. Conventional statistical procedures may be implemented to complete this step. A variety of different distribution functions may be utilized (e.g., normal, log-normal, triangular, etc.) A normal distribution function may be generated based on the mean and standard duration for the variable of interest. A log normal distribution may be generated based on the parameters μ and Σ for the variable of interest. A triangular distribution function may be generated based on minimum, mode and maximum values for the variable of interest.

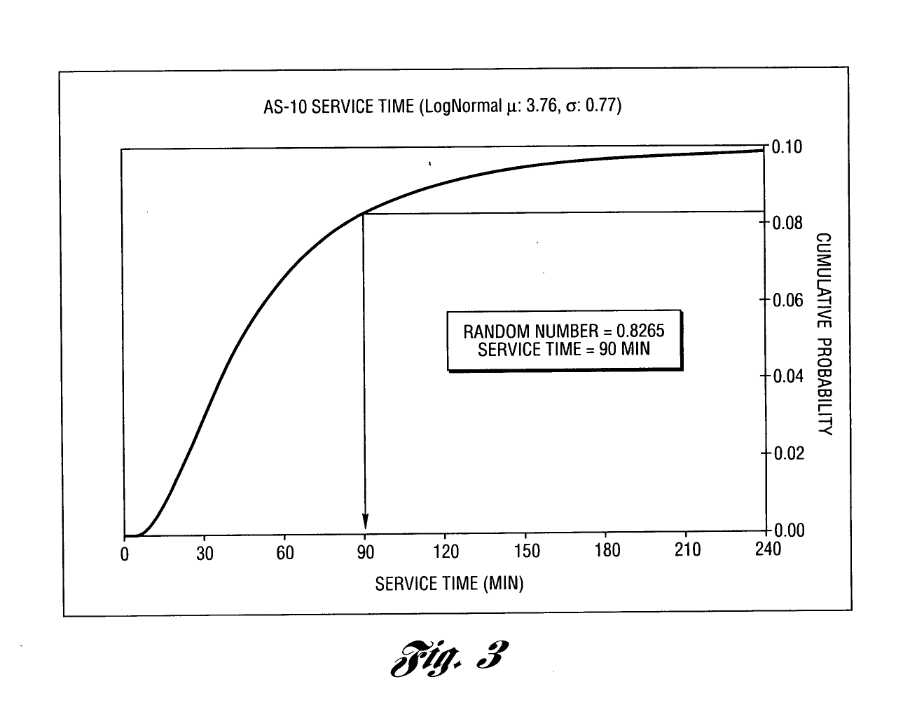

Second, a random number between 0 and 1 is generated for a particular instance of the variable of interest. Next, the random number is converted into a discrete value for the variable of interest. FIG. 3 illustrates an example of this conversion for the “A-10 Service Time” log-normal distribution function. In this example, a randomly-generated number 0.8265 corresponds to an AS-10 Service Time of 90 minutes.

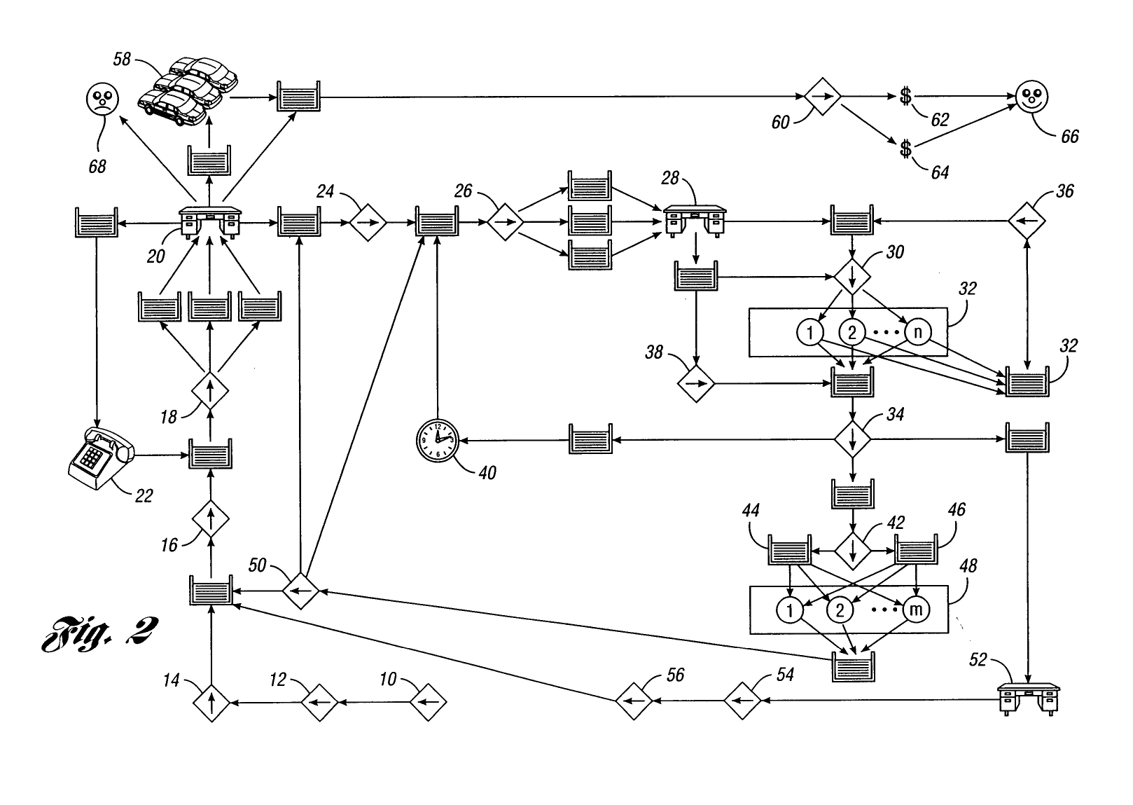

FIG. 2 is a schematic representation of a simulated automobile service facility generated in accordance with a preferred embodiment of the recent invention. Location 10 simulates customer arrivals at the service facility. Customer arrivals are simulated based upon an inter-arrival time distribution. Also at location 10, a random number of service items are assigned to each arriving customer based upon predefined repair count probabilities.

At location 12, desired service types are allocated. This process includes randomly assigning a specific service type to each service item based upon the predefined service type probabilities. For each service item, quantitative or binary values for attributes such as those contained in Table 8 are assigned based upon their respective distribution functions, regression coefficients and dealer-specific characteristics.

TABLE 8

Total flat rate service time
Diagnosis flat rate service time
Repair flat rate service time
Service revenue
Part revenue
Wait time for parts
Parts available (yes or no)
Customer will authorize work (yes or no)
Customer will exit dealer due to long
part wait (yes or no)

At location 14, a yes/no decision is made as to whether the customer will wait in the service facility lounge during service is made. In one embodiment, a decision is made by generating a random number between 0 and 1 and comparing the random number to the probability that customers will wait in the lounge (model input). If the random number is less than the input probability, the model designates the customer as waiting in the lounge. Also at location 14, a yes/no decision(s) is(are) is made as to whether technician diagnosis is necessary based upon the requested service type(s). This decision is typically defined by the service type. For example, service types AS-10, AS-12 and W-01 though W-08 do not require diagnosis.

At locations 16 and 18, service desk routing control takes place based upon the number of times a customer or service order has visited the respective service desk. In one embodiment, the model exercises route control via a counting function. For example, at location 16, the model adds 1 to the current value of the counter. At location 18, the model routes all repair orders with a counter value=1 to the Write-up loop, counter value=2 to the Cust Okay loop, and counter value=3 to the Cust Notify loop.

At service desk location 20, one of the following functions will be performed: a first visit to service desk (Repair Order Write-up); a second visit to service desk (Customer Authorization of All Repair Items); or a third visit to service desk (Customer Notification of work Completion) The model assigns the time at the service desk based upon the function performed (write-up, customer authorization, or customer notification) and the associated work time distribution function. A yes/no decision is made as to whether the customer answers the telephone when called to obtain authorization for service. The yes/no decision process is similar to the process at location 14 associated with the customer waiting in the lounge.

Routing control also takes place at location 20. Example service routes include the dispatch desk 28 for diagnosis or service, a customer callback at location 22 if the customer is unavailable when attempting to obtain work authorization, the cashier's desk 62/64 if the work is complete and the customer is waiting in the service facility lounge, the parking lot 70 if the service is complete and the customer is not waiting in the service facility lounge, and lost business 68 if the customer refuses authorization for all items and/or refuses to wait for parts on all items.

At location 22, a customer callback occurs. In one embodiment, a routing from the service desk may be controlled by evaluating the number of trips to the service desk (as well as other factors) and assigning a routing number to the repair order according to Table 9.

TABLE 9

| | ROUTING | |
|---|---|---|
| FACTORS | NUMBER | ROUTE |
| First visit to service | 1 | To dispatch desk |
| desk or | | (location 28) |
| Second visit to service | | |
| desk and | | |
| Customer waiting in | | |
| lounge or | | |
| Second visit to service | | |
| desk and | | |
| Customer not waiting in | | |
| lounge and | | |
| Customer answers | | |
| authorization call. | | |
| Second visit to service | 2 | To customer |
| desk and | | callback hold |
| Customer not waiting in | | (location 22) |
| lounge and | | |
| Customer does not | | |
| answer authorization call. | | |
| Second visit to service | 3 | To lost business |
| desk and | | (location 68) |
| Customer fails to | | |
| authorize all service or | | |
| refuses to wait for parts. | | |
| Third visit to service | 4 | To cashier |
| desk and | | (locations 62, |
| Customer waiting in | | 42) |
| lounge. | | |
| Third visit to service | 5 | To parking lot |
| desk and | | (location 58) |
| Customer not waiting in | | |
| lounge. | | |

The model assigns the waiting time for customer callback based upon the callback distribution function.

At dispatch desk locations 24 and 26, routing control takes place based upon the number of times a repair order has visited the dispatch desk. The model exercises route control via a counting function similar to that occurring at locations 16 and 18. One of the following functions will be performed: (a) first visit to dispatch desk—repair order dispatch for diagnosis (if diagnosis required); (b) second visit to dispatch desk—repair order dispatch for service; (c) third visit to dispatch desk—repair order closeout.

At dispatch desk location 28, one of the following will occur. For the first visit to the dispatch desk, the repair order is dispatched for diagnosis (if required). For the second visit, the repair order is dispatched for service. For the third visit, the repair order is closed out. The model assigns the time at the dispatch desk based upon the function performed (diagnosis dispatch, service dispatch, or closeout) and the associated work time distribution function. Routing from the dispatch desk is controlled by observing the number of visits to the dispatch desk and routing as follows. If the first or second visit to dispatch desk, route to location 30 for selection of the repair item to be dispatch. If the third visit to dispatch desk, route to location 38 for ultimate routing to the booking desk.

At location 30, general dispatch control dispatches the repair order. The first item on the repair order is considered. If dispatching is required, the repair order is routed to the slot in location 32 associated with the desired service type. If dispatching is not required, the second item on the repair order is considered and dispatched as applicable. This process repeats until all items on the repair order have been considered. Once all items have been dispatched (as applicable), the repair order is routed to location 38.

At location 32, specific dispatch control attempts to assign a technician to the repair order based on the technician skill matrix and technician availability. If a qualified technician is available, the technician is assigned and the repair order is routed to location 34. If a qualified technician is not available, the repair order is routed to location 36 to attempt dispatching of another item on the repair order.

At dispatch desk location 34, routing out of the dispatch desk is controlled between service bays 48 for diagnosis or service, the booking desk 52 for repair order processing or waiting area 40 if no technicians or parts are available.

Location 36 routes repair orders back to the dispatch logic (location 30) to attempt another dispatch function. Location 38 passes repair orders to location 34 for additional routing to either technician and part hold (location 40) or service bays (location 48). An example illustrates the interrelated functions of locations 30, 32, 36, and 38. A repair order enters location 30 requiring diagnosis dispatch of several repair order items: item 1 (service type=AS-11); item 2 (service type=W.1); item 3 (service type=AS-170), etc. Location 30 performs the following steps: subsequently evaluates items 1 through 7 to see if dispatching is required; observes that item 1 requires dispatching; ignores items 2 through 7 and routes the repair order to the AS-11 slot in location 32. Location 32 performs the following steps: the AS-112 slot in location 32 attempts to assign a qualified technician; if a technician is available, the technician is assigned and the repair order proceeds to location 34 for additional routing to the service bays (location 48); and if a technician is not available, the repair order proceeds to location 36. Location 36 routes the repair order to location 30 to evaluate repair order items 2 through 7 for dispatching. Location 30 performs the following steps: sequentially evaluates items 2 through 7 to see if dispatching is required; observes that item 3 requires dispatching; and routes the repair order to the AS-17 slot in location 32. Location 32 performs the following steps: the AS-17 slot in location 32 attempts to assign a qualified technician; if a technician is available the technician is assigned and the repair order proceeds to location 34 for additional routing to the service bays (location 48); and if a technician is not available, the repair order proceeds to location 36. Location 36 routes the repair order to location 30 to evaluate repair order items 4 through 7 for dispatching. Location 30 performs the following steps: sequentially evacuates items 4 through 7 to see if dispatching is required; and observes that no items require dispatching and routes the repair order to location 38 for additional routing to technician and part wait (location 40) because no items were dispatched (technicians were previously unavailable for items 1 and 3).

At technician and part wait location 40, the model assigns the time in location 40. For example, if waiting for a technician, wait time=10 minutes, and if waiting for parts, the wait time is determined from the associated service type distribution function.

Location 42 governs service bay routing control for allocating service bays between diagnosis and service. The routing control is similar to that performed by locations 16 and 18 except it is performed in a single location.

Locations 44 (diagnosis control) and 46 (service control) route repair orders to the service bays based on the technician assigned during the dispatch function performed in location 32.

At service bay locations 48, the technician performs the required diagnosis or service. The model assigns a time at location 48 from the values previously determined at location 12.

At service bay exit location 50, statistics such as cumulative diagnosis time, cumulative service time and cumulative service bay time (based upon service type and assigned technician) may be calculated. Location 50 also governs routing control out of the service bays to the service desk for customer authorization, the dispatch desk for diagnosis and service dispatch, and the dispatch desk for service order closeout.

At booking desk location 52, statistics such as labor revenue for each service item on the service order, part revenue for each service item on the service order, cumulative total labor revenue and cumulative total part revenue may be calculated. The model assigns the time at the booking desk from the associated work time distribution function.

At location 54, accounting statistics such as cumulative labor revenue for each service type and cumulative part revenue for each service type may be calculated. At location 56, a cumulative count of services through the booking desk may be collected.

At parking location 58, the model assigns a parking time to each repair order (vehicle) according to the following example relationship: Parking time=(Day End Time−Parking Window Time−Time Enter Parking)+((Random Number*Parking Window Time)−5).

Location 60 passes repair orders to locations 62 or 64 depending upon which cashier is available (not busy with a customer). At full-time and part-time cashier locations 62 and 64, respectively, the model assigns the time at the cashier from the associated work time distribution function. Statistics such as total time in dealership, cumulative count repair orders (customers), cumulative total work time at each service facility location, and cumulative total wait (queue) times at each service facility work location may be calculated or compiled.

At exit location 66, automobile service is complete. At exit location 68, customers (repair orders) exit the dealership without completing service. For example, a customer may withhold work authorization due to high cost or refuse to wait for parts. Routing to location 68 is controlled by location 20 (previously discussed).

Typically, a wide variety of quantitative and/or qualitative factors are input into a model or simulation. When modeling a service repair facility, it is not uncommon to have hundreds of different input factors. (Notably, a high number of input factors is not necessary for a successful implementation of the present invention.) In many instances, however, only a relative few of these input factors have a significant impact on efficiency/revenue of an automobile service facility.

In accordance with a preferred embodiment of the present invention, iterative computer experiments are performed to identify and quantify the impact of input factors having a material effect on automobile service facility efficiency/revenue.

Preferably, although not necessarily, the computer experiments occur in two phases. During Phase I, several screening experiments (e.g., between 5 and 10, etc.) are performed on subsets of factors to identify those having a material impact on service facility efficiency/revenue. For example, the screening experiments may evaluate the following seven groups of factors:
Effective labor rates—18 factors;
Part pricing—18 factors;
Headcount rationalization—7 factors;
New technician skills—10 factors;
Technician hours—21 factors;
Technician efficiency—11 factors; and
Incremental technician skills—58 factors.

Phase II may involve an experiment that evaluates each of the significant factors identified in Phase I. During Phase II, equations may be derived that define a quantitative relationship between the important metrics and the significant factors. Equation 1 represents an example expression:
Revenue per week=83,729+527C—255F+289I+294L+472M (1)

In this example, assume:

| | |
|---|---|
| Current Revenue/Week = | 82,402 |
| Tech 05 efficiency improvement (C) = | 1,054 |
| Tech 18 add AS-11 (M) = | 944 |
| Tech 12 add AS-16 (L) = | 588 |
| Tech 11 add AS-11 (I) = | 578 |
| Do not hire new tech with AS = 13 (F) = | 0 |
| Optimum Revenue/Week = | 85,566 |
| Improvement (weekly) = | 3,164 (3.8%) |
| Improvement (annual) = | 158,200 |

Having a quantitative relationship such as that provided in Equation 1 enables an analyst/service facility manager to effectively determine (based on realistic quantitative data) what facility changes are most likely to have a positive impact on the performance and efficiency of the service facility. Due to the relative nature of the factors that make up the expression, an analyst/service facility manager can estimate both the relative individual and cumulative impacts certain facility changes may have.

While the best mode for carrying out the invention has been described in detail, those familiar with the art to which this invention relates will recognize various alternative designs and embodiments for practicing the invention as defined by the following claims.

1. A system for modeling an automobile service facility, the system comprising a computer configured to:
receive input data defining customer characteristics, facility capabilities, and financial data for an automobile service facility;
generate a computer model of the service facility based on the customer characteristics, facility capabilities, and financial data; and
output one or more quantitative indications of expected facility performance based on the model.

2. The system of claim 1 wherein the computer is additionally configured to receive input defining a computer experiment to identify one or more service facility characteristics that have an impact on service facility efficiency or revenue.

3. The system of claim 2 wherein the computer is additionally configured to calculate and output an equation quantitatively interrelating one or more of the service facility characteristics that have an impact on service facility efficiency or revenue.

4. The system of claim 1 wherein the model utilizes probability to account for uncertainty in at least a portion of the input data.

5. The system of claim 1 wherein the customer characteristics include customer arrival rates, desired services, or the number of desired services per customer.

6. The system of claim 1 wherein the facility capabilities include personnel quantities, technician skills, technician efficiency, work hours, or personnel absences.

7. The system of claim 1 wherein the facility capabilities include one or more statistical indicia of one or more service times associated with customer experiences at the service facility.

8. The system of claim 1 wherein the financial data includes one or more statistical indicia of part and labor revenue associated with one or more service types.

9. The system of claim 1 wherein the one or more quantitative indication(s) of expected facility performance include expected financial performance, technician utilization, or time to process customers.

10. The system of claim 9 wherein the time to process customers includes a time to process discrete customer services or a time of overall customer experience at the service facility.

11. A method for modeling an automobile service facility, the method comprising a computer configured to:
receiving data defining customer characteristics, facility capabilities and financial data for an automobile service facility;
generating a computer model of the service facility based on the customer characteristics, facility capabilities, and financial data; and
calculating one or more quantitative indications of expected facility performance based on the model.

12. The method of claim 11 additionally comprising conducting a computer experiment to identify one or more service facility characteristics that have an impact on service facility efficiency or revenue.

13. The method of claim 12 wherein the computer experiment results in a quantitative expression interrelating one or more of the service facility characteristics that have an impact on service facility efficiency or revenue.

14. The method of claim 13 additionally comprising changing the operation of the service facility to improve efficiency or revenue based at least in part on the relative quantitative significance of factors making up the quantitative expression.

15. The method of claim 11 wherein the model utilizes probability to account for uncertainty in at least a portion of the received data.

16. The method of claim 11 wherein the customer characteristics include customer arrival rates, desired services, or the number of desired services per customer.

17. The method of claim 11 wherein the facility capabilities include personnel quantities, technician skills, technician efficiency, work hours, or personnel absences.

18. The method of claim 11 wherein the facility capabilities include one or more statistical indicia of one or more service times associated with customer experiences at the service facility.

19. The method of claim 11 wherein the financial data includes one or more statistical indicia of part and labor revenue associated with one or more service types.

20. The method of claim 11 wherein the one or more quantitative indication(s) of expected facility performance include expected financial performance, technician utilization, or time to process customers.

21. The method of claim 20 wherein the time to process customers includes the time to process discrete customer services or the time of overall customer experience at the service facility.

22. A method for modeling an automobile service facility, the method comprising:
defining customer characteristics, facility capabilities, and financial data for an automobile service facility;
a step for generating a computer model of the service facility based on the customer characteristics, facility capabilities, and financial data wherein at least one quantitative indication of expected facility performance based on the model is calculated.

23. The method of claim 22 additionally comprising a step for conducting one or more computer experiments to define a quantitative expression interrelating one or more factors that impact service facility revenue or efficiency.
